(19) United States
(12) Patent Application Publication
(10) Pub. No.: US 2008/0134227 A1
(43) Pub. Date: Jun. 5, 2008

(54) OPTICAL DISC APPARATUS

(75) Inventor: Naoki EGUCHI, Yokohama-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/947,405

(22) Filed: Nov. 29, 2007

(30) Foreign Application Priority Data
Nov. 30, 2006 (JP) 2006-324805

(51) Int. Cl. G11B 19/20

(52) U.S. Cl. 720/703; 720/704

(57) ABSTRACT

According to one embodiment, an optical disc apparatus according to an embodiment of the present invention has a loading arm. The loading arm has two projections provided, respectively, at a distal end and at a position prescribed in accordance with a difference in diameter between optical discs. The loading arm can rotate in a direction in which an optical disc is inserted. It rotates when the optical disc contacts at least the projection provided at the distal end. It positions the optical disc when it is rotated through an angle prescribed in accordance with the difference in diameter between the optical discs, by using the two projections spaced apart by a distance prescribed in accordance with the difference in diameter between the optical discs. When the loading arm is rotated in the opposite direction, the optical disc is ejected from the optical disc apparatus.

### CROSS-REFERENCE TO RELATED APPLICATIONS

This application is based upon and claims the benefit of priority from Japanese Patent Application No. 2006-324805, filed Nov. 30, 2006, the entire contents of which are incorporated herein by reference.

### BACKGROUND

1. Field

One embodiment of the present invention relates to an optical disc apparatus that can read data from a disc recording medium, such as an optical disc, and can write data to the optical disc.

2. Description of the Related Art

Optical disc apparatuses (optical disc drives) have long been in practical use, each configured to apply a laser beam to an optical disc, thereby reproducing data from the optical disc and recording data on the optical disc.

The optical disc drive includes an optical pickup (optical head) device, a loading mechanism, a disc motor, and a control circuit. The optical pickup is moved radially across the data-recording surface of an optical disc. While being so moved, the optical pickup can read data from and write data to the optical disc. The loading mechanism is configured to load an optical disc to a prescribed position (in the optical disc drive) and to eject the disc reliably from the optical disc drive. The disc motor rotates the optical disc. The control circuit performs miscellaneous control to record data on and reproduce data from the optical disc.

Small optical discs (of diameter 8 cm) are used today as recording media in video cameras.

It is therefore demanded that the optical disc drive should read data from and write it to both a conventional 12-cm optical disc and an 8-cm optical disc.

Japanese Patent Application Publication (KOKAI) No. 2005-190645 discloses an optical disc drive. The optical disc drive has a plurality of rotation arms that can rotate between a major surface opposing the disc mount and a major surface of the disc inserted through the disc insertion/ejection slot. While holding the outer circumferential part of the disc inserted through the disc insertion/ejection slot, the rotation arms perform various operations. That is, they pull the disc from the slot into the housing, loading the optical disc. They position the disc at the disc mount, centering the optical disc. They move the disc out of the housing through the disc insertion/ejection slot, ejecting the optical disc.

Japanese Patent Application Publication (KOKAI) No. 2005-190646 discloses an optical disc drive, too. This optical disc drive has first and second rotation arms that are arranged, opposing each other across a turntable. The first and second rotation arms are rotatably supported at proximal end that lies closer to the back than the turntable. The distal end parts of the first and second rotation arms, which lie closer to the front than the turntable, can rotate in a plane parallel to the major surface of the optical disc inserted through the disc insertion/ejection slot. Two discs having different diameters may be held between the abutting members fastened to the first and second rotation arms, respectively. In this case, the center holes of the discs can be aligned with the engagement projection provided on the turntable.

Japanese Patent Application Publication (KOKAI) No. 2006-251362 discloses an optical disc drive that comprises a slider, a pair of guide members, rotation arms, and coupling gears. The slider can move in the direction an optical disc is transported. The guide members are secured to the slider and biased to move toward each other, in a direction at right angles to the direction the optical disc is transported. Each rotation arm has a guide roller at the distal end, for holding the outer circumference of the optical disc, and is rotatably attached to the slider at the proximal end. The coupling gears are provided on the slider and can move the guide members toward and away from each other. When an optical disc is inserted into the optical disc drive, the coupling gears move the guide members away from each other. Thus moved, the optical disc rotates the rotation arms, whereby the guide rollers hold the optical disc. The slider is therefore moved in the direction the optical disc is inserted. As a result, the optical disc is moved to the position where it should be rotated, while it is being held by the guide rollers.

The optical disc drives disclosed in the above-identified patent documents can indeed use both a 12- and an 8-cm optical disc. However, they use two or more arm members. Inevitably, not only the disc-transporting mechanism and the disc-positioning mechanism will be complex, but also the weight of the optical disc drive will increase.

This means that any portable apparatus incorporating the optical disc drive, such as a personal computer, is unavoidably heavy.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a diagram showing an example of an optical disc apparatus (optical disc drive) according to an embodiment of the invention;

FIG. 2 is a diagram showing a 12-cm optical disc being inserted into the optical disc apparatus (FIG. 1) according to the embodiment of the invention;

FIG. 3 is a diagram showing an example of the 12-cm optical disc being inserted deeper into the optical disc apparatus according to the embodiment of the invention;

FIG. 4 is a diagram showing an 8-cm optical disc being inserted into the optical disc apparatus according to the embodiment of the invention;

FIG. 5 is a diagram showing the 8-cm optical disc being inserted deeper into the optical disc apparatus according to the embodiment of the invention;

FIG. 6 is an exemplary diagram showing a 12-cm optical disc clamped in the optical disc apparatus according to the embodiment of the invention;

FIG. 7 is a diagram showing an 8-cm optical disc clamped in the optical disc apparatus according to the embodiment of the invention;

FIGS. 8A and 8B are exemplary diagrams, each showing, in detail, how a 12-cm optical disc is inserted into the optical disc apparatus according to the embodiment of the invention;

FIGS. 9A and 9B are diagrams, each showing, in detail, how an 8-cm optical disc is inserted into the optical disc apparatus according to the embodiment of the invention; and

FIG. 10 is a diagram showing the loading arms and the disc holding lever, both at receded positions, so that optical disc inserted can rotate in the optical disc apparatus according to the embodiment of the invention.

### DETAILED DESCRIPTION

Various embodiments according to the invention will be described hereinafter with reference to the accompanying drawings. In general, according to one embodiment of the invention, an optical disc apparatus comprising: a turntable which supports an optical disc, rotating a recording surface of the optical-disc at a predetermined speed; an arm member which rotates around a fulcrum located at the rear of the turn table, with respect to a direction of inserting the optical-disc and guiding the same to the turntable, and which has at least two projections spaced apart for a distance corresponding to the diameter of the optical disc; a guide unit which rotates around a fulcrum set at a prescribed position, not interfering the optical disc being guided to the turntable and remaining opposed to the arm member across the turntable, which has an guiding member able to contact, at least at one point, an outer circumference of the optical disc to be guided to the turntable, and which guides the optical disc toward the arm member; guide members which guides an optical disc having a first diameter to the arm member, while remaining at a first position, and to guide an optical disc having a second diameter larger than the first diameter, while remaining at a second position where the guide members are spaced by a longer distance than while remaining at the first position; and a cam slider which controls first the rotation of the arm member and the rotation of the guide unit in series.

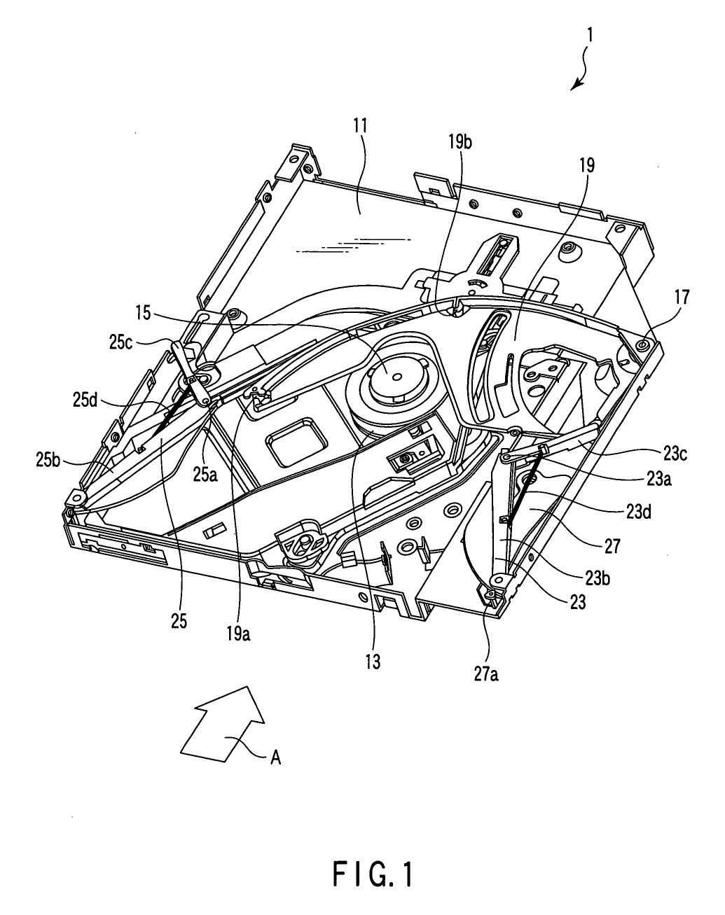

FIG. 1 shows an example of an optical disc apparatus (optical disc drive) according to an embodiment of the invention. The optical disc apparatus shown in FIG. 1 is a so-called slot-in type, in which an optical disc is inserted so that data may be recorded on and reproduced from, the optical disc. The optical disc apparatus is designed for use in, for example, portable personal computers (notebook PCs). FIG. 1 shows the optical disc apparatus, with some parts of the housing having been removed.

As shown in FIG. 1, the optical disc apparatus 1 has a housing (bottom cover) 11 and a disc motor 13 mounted on the center of the housing 11. On the shaft (not shown) of the disc motor 13, a turntable 15 is mounted to hold an optical disc.

Near the turntable 15 (hence, near the disc motor 13), a loading arm 19 is provided. The loading arm 19 can rotate around a fulcrum 17 that is provided at a prescribed position on the housing 11.

The loading arm 19 has a first positioning projection 19a and a second positioning projection 19b. The first positioning projection 19a is positioned at prescribed distances from the fulcrum 17. It can contact the circumference of an optical disc inserted toward the turntable 15 in the direction of arrow A. The second positioning projection 19b is positioned between the first positioning projection 19a and the fulcrum 17. The first positioning projection 19a is positioned and shaped to contact the circumference of an optical disc before the recording surface of the optical disc contacts the turntable 15, regardless of the diameter of the optical disc being inserted in the direction of arrow A. The second positioning projection 19b is positioned and shaped to contact the circumference of an optical disc when its center hole substantially aligns with the center of the turntable 15, regardless of the diameter of the optical disc being inserted in the direction of arrow A.

A first disc guide 23 and a second disc guide 25 are provided on two opposing edges of the housing 11, respectively. (In other words, the first disc guide 23 and the second disc guide 25 are located on the right and left of the turn table 15, respectively, as viewed in the direction of arrow A.) The first disc guide 23 and the second disc guide 25 cooperate with the loading arm 19 to support an optical disc being inserted in the direction of arrow A and to guide the optical disc to the loading arm 19. The first and second disc guides 23 and 25 oppose each other across the turntable 15. Thus, the turntable 15 lies between the guides 23 and 25, as viewed in a direction parallel to the shaft of the disc motor 13 that supports the turn table 15.

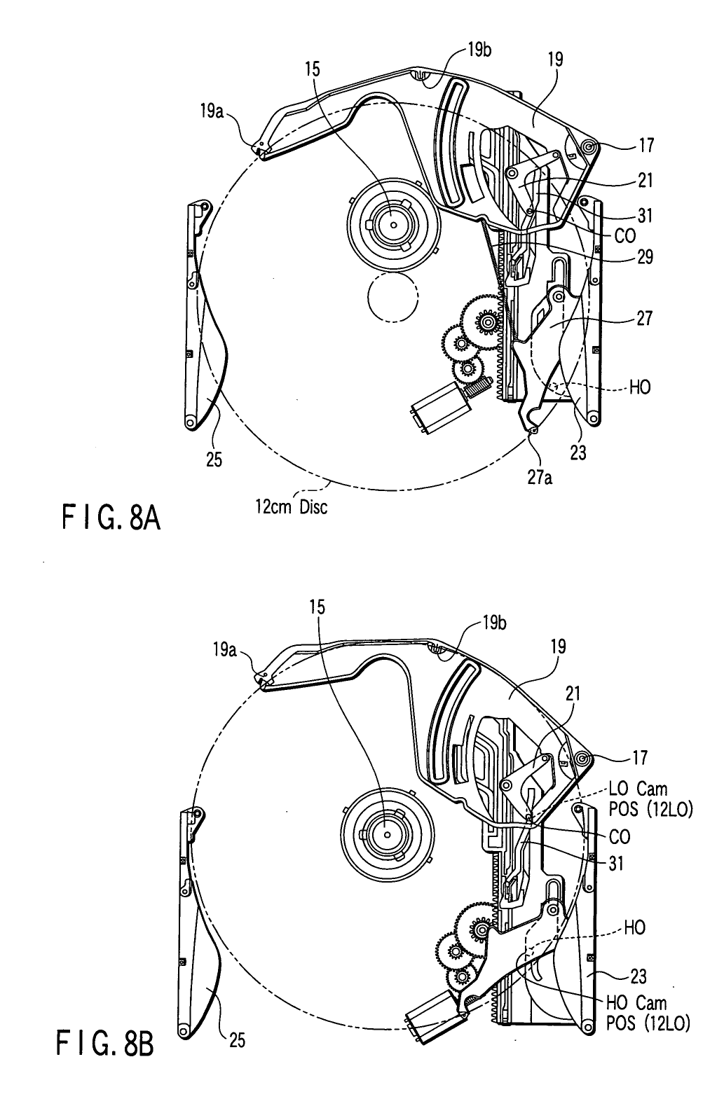

In the vicinity of the first disc guide 23, a disc holding lever 27 is provided. The disc holding lever 27 has a disc holding pin 27a that cooperates with the first positioning projection 19a to hold the optical disc (being inserted in the direction of arrow A). The disc holding lever 27 can rotate toward the turntable 15, around a fulcrum 27b provided at a prescribed position on the lever 27. The disc holding lever 27 and the loading arm 19 are biased toward each other by a spring member 29 shown in FIGS. 8A and 8B (not shown in FIG. 1). That is, the spring member 29 always exerts a force that pulls the disc holding lever 27 and the loading arm 19 toward each other and toward the circumference of the turntable 15.

The first disc guide 23 is composed of a fulcrum 23a, a main disc guide 23b, an auxiliary disc guide 23c and a spring member 23d. The fulcrum 23a couples the main disc guide 23b and the auxiliary disc guide 23c. The spring member 23d exerts a force (tension) that pulls the main disc guide 23b and the auxiliary disc guide 23c toward each other. The-second disc guide 25 is composed of a fulcrum 25a, a main disc guide 25b, an auxiliary disc guide 25c and a spring member 25d. The fulcrum 25a couples the main disc guide 25b and the auxiliary disc guide 25c. The spring member 25d exerts a force (tension) that pulls the main disc guide 25b and the auxiliary disc guide 25c toward each other.

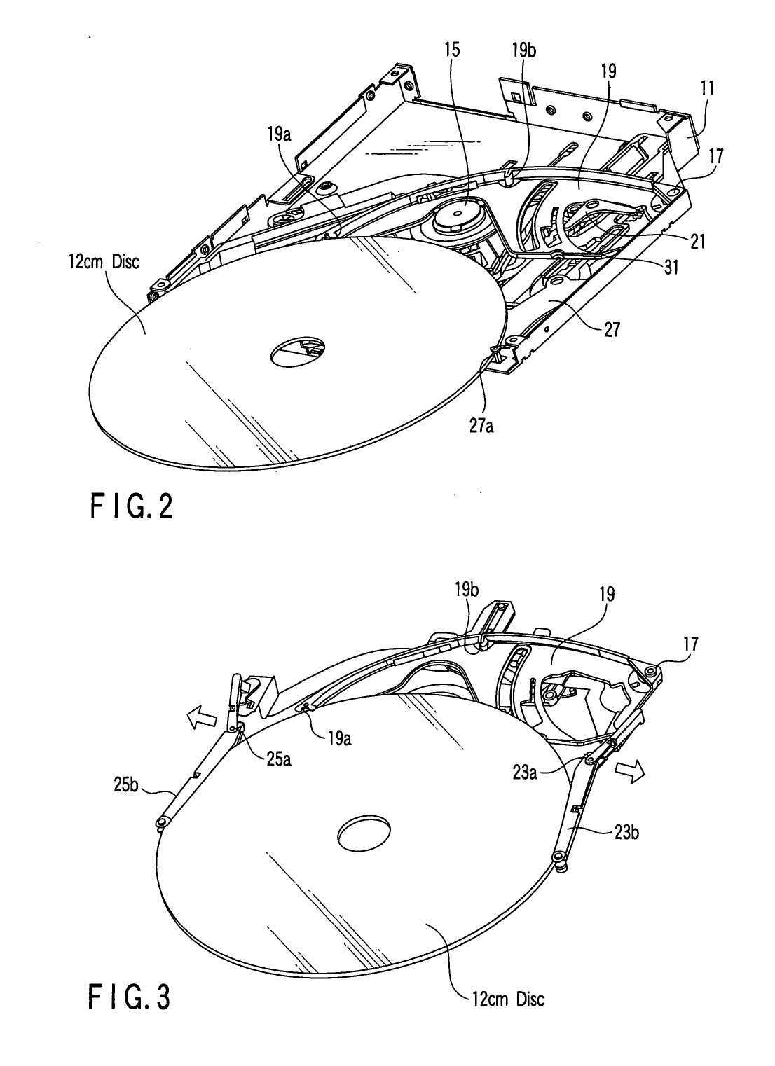

FIGS. 2 and 3 show how an optical disc of a first size, for example, an optical disc of diameter 12 cm, is inserted into the optical disc apparatus (optical disc drive) shown in FIG. 1. FIG. 2 shows the optical disc contacting, at its outer circumference, the disc holding pin 27a of the disc holding lever 27 and the first positioning projection 19a of the loading arm 19. FIG. 3 shows the positional relation the optical disc has with the first and second disc guides 23 and 25 while it is being inserted.

As shown in FIG. 2, an optical disc (12-cm disc) is inserted (or pushed) into the optical disc apparatus 1 in the direction of arrow A. The outer circumference of the optical disc eventually contacts the disc holding pin 27a of the disc holding lever 27. The optical disc is then guided toward the loading arm 19 (and toward the turntable 15) and contacts the first positioning projection 19a of the loading arm 19. As described above, the disc holding lever 27 and the loading arm 19 are exerted with a predetermined tension and pulled toward the turntable 15. The optical disc is therefore guided to the turntable 15, while being supported by the disc holding lever 27 and the loading arm 19.

As the optical disc is further pushed, the loading arm 19 rotates around the fulcrum 17, moving away from the turntable 15.

As the optical disc is inserted still further into the optical disc apparatus 1 (or as the loading arm 19 is rotated), the fulcrum 23a of the first disc guide 23 and the fulcrum 25a of the second disc guide 25 are gradually moved outwards, preventing the optical disc from moving in any undesirable manner.

As the optical disc is inserted deeper into the apparatus 1, the fulcrums 23a and 25a of the first and second disc guides 23 and 25, respectively, are moved their outermost positions as shown in FIG. 8A. As a result, the main disc guide 23b and auxiliary disc guide 23c of the first disc guide 23 extend in a substantially straight line, and the main disc guide 25b and auxiliary disc guide 25c of the second disc guide 25 extend in a substantially straight line as shown in FIG. 8A. Then, the disc holding lever 27 and the loading arm 19 transports the optical disc until the center of the optical disc reaches the turntable 15.

As the disc holding lever 27 and the loading arm 19 are rotated, the optical disc held by the disc holding lever 27 and the loading arm 19 is further transported until its center aligns with the center of the turntable 15 as shown in FIG. 8B. At this point, the first and second positioning projections 19a and 19b of the loading arm 19 cooperate, reliably aligning the center of the optical disc with the center of the turntable 15.

More precisely, as the 12-cm disc is inserted into the optical disc apparatus 1, the first and second disc guide 23 and 25 are moved outwards. When the optical disc reaches a sufficiently deep position (FIG. 8A), a cam slider 31 is driven by a loading motor (not shown), further transporting the optical disc held between the first and second positioning projections 19a and 19b of the loading arm 19 and the disc holding pin 27a of the disc holding lever 27.

As the cam slider 31 further slides, the engagement projection CO of a connection lever 21 enters an LO cam POS (12LO). Then, the first and second positioning projections 19a and 19b of the loading arm 19 are moved, guiding the optical disc until the center of the disc aligns with the center of the turntable 15 (or the shaft of the disc motor 13). At the same time, the engagement projection HO of the disc holding lever 27 enters an HO cam POS (12LO). Then, the disc holding pin 27a moves, pushing the optical disc until the center of the disc aligns with the center of the turntable 15 (or the shaft of the disc motor 13). The optical disc is thereby set at a prescribed position on the turntable 15, where it should be clamped.

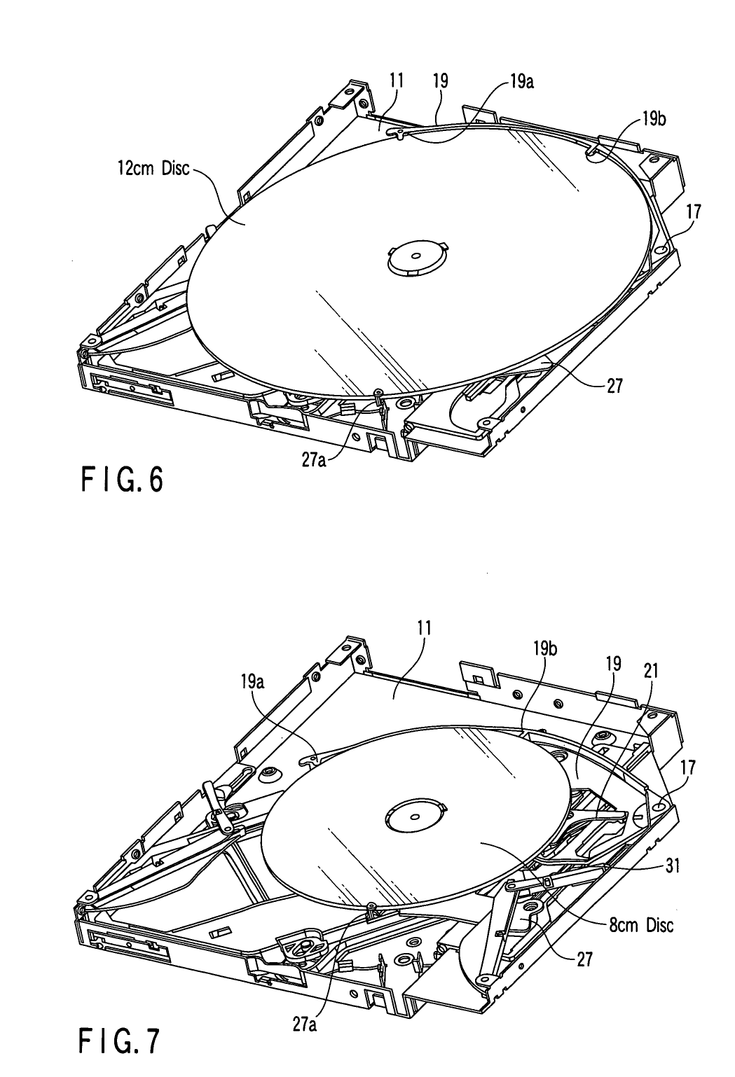

Although not described in detail, as the optical disc is inserted into the optical disc apparatus 1, the turntable 15 (disc motor 13) is moved upwards from the bottom cover (housing) 11. The optical disc is thereby clamped on the turntable 15. As a result, the optical disc is set in the optical disc apparatus 1 and can be rotated, as shown in FIG. 6.

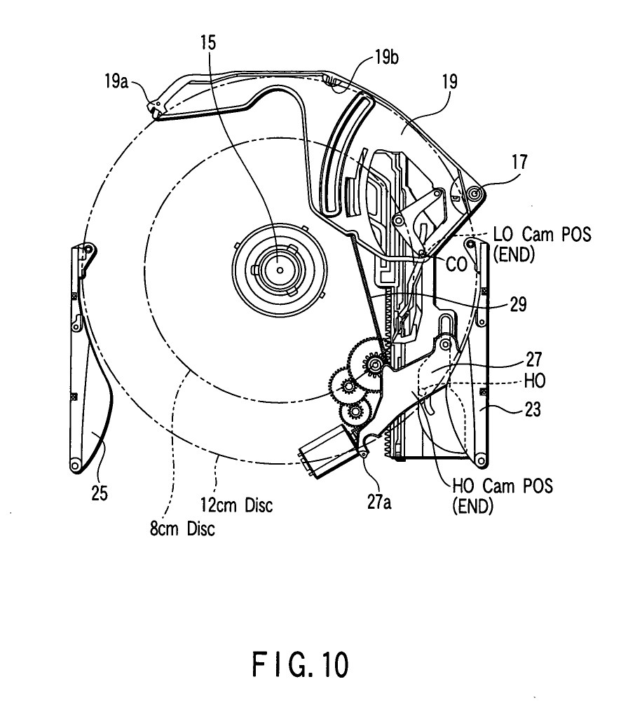

In order to rotate the 12-cm optical disc, a spring-force releasing mechanism (not shown) releases the disc holding lever 27 and the loading arm 19 from the tension that biases them toward the turntable 15 shown in FIG. 10. Thus, the disc holding lever 27 and the loading arm 19 are inhibited from contacting the outer circumference of the 12-cm optical disc.

In order to eject the 12-cm optical disc, the loading arm 19 is rotated in the opposite direction (to move the optical disc to the disc-ejecting position). The 12-cm optical disc can therefore be ejected with ease.

How an 8-cm optical disc is loaded into the optical disc apparatus 1 will be explained.

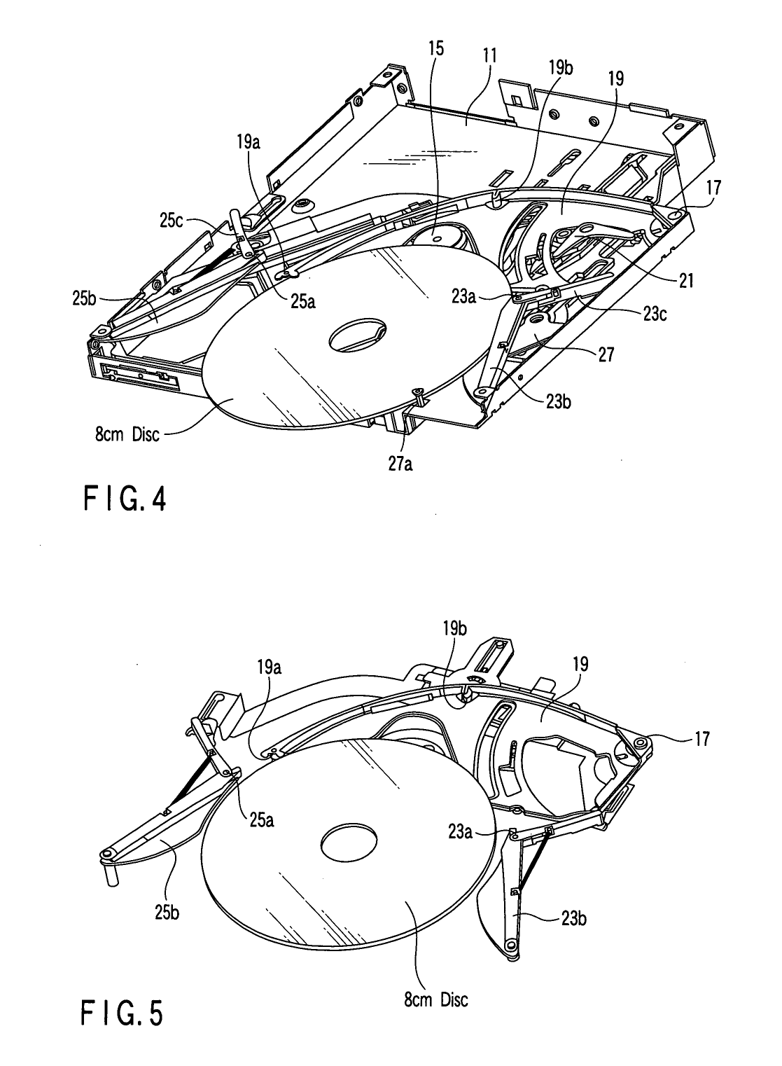

FIGS. 4 and 5 show how an optical disc of a second size, for example, an optical disc of diameter 8 cm, is inserted into the optical disc apparatus (optical disc drive) shown in FIG. 1. FIG. 4 shows the optical disc contacting, at its outer circumference, the disc holding pin 27a of the disc holding lever 27 and the first positioning projection 19a of the loading arm 19. FIG. 5 shows the positional relation the optical disc has with the first and second disc guides 23 and 25 while it is being inserted.

As shown in FIG. 4, an optical disc (8-cm disc) is inserted (or pushed) into the optical disc apparatus 1 in the direction of arrow A. The outer circumference of the optical disc eventually contacts the disc holding pin 27a of the disc holding lever 27. The optical disc is then guided toward the loading arm 19 (and toward the turntable 15) and contacts the first positioning projection 19a of the loading arm 19. As described above, the disc holding lever 27 and the loading arm 19 are exerted with a predetermined tension and pulled toward the turntable 15. The optical disc is therefore guided to the turntable 15, while being supported by the disc holding lever 27 and the loading arm 19.

As the optical disc is further pushed, the loading arm 19 rotates around the fulcrum 17, moving away from the turntable 15.

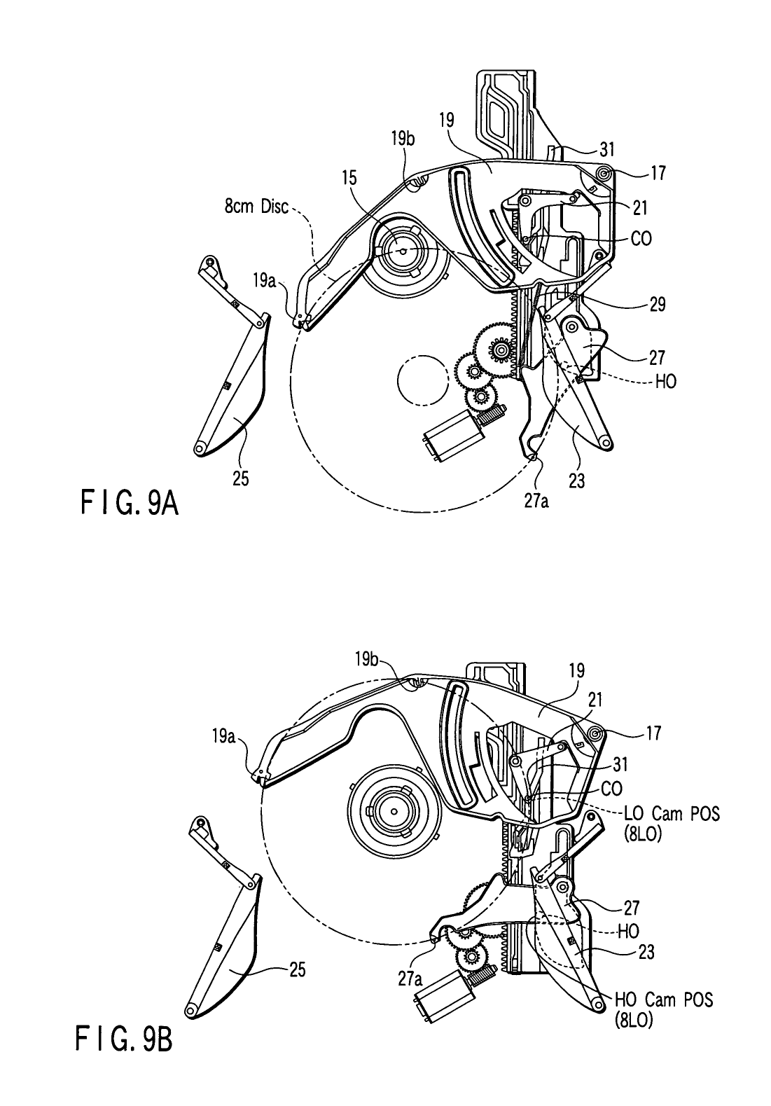

At this time, the fulcrums 23a and 25b of the first and second disc guides 23 and 25, respectively, prevent the optical disc from moving in any undesirable manner. They can yet position the optical disc at substantially the center of the optical disc apparatus 1, almost at their initial positions or virtually without rotating (see FIGS. 9A and 9B), unlike in the case where a 12-cm disc is inserted into the optical disc apparatus 1. FIG. 9A shows the optical disc immediately before its center aligns with the center of the turntable 15.

As the disc holding lever 27 and the loading arm 19 are rotated, the optical disc held by the disc holding lever 27 and the loading arm 19 is further transported until its center aligns with the center of the turntable 15 as shown in FIG. 9B. At this point, the first and second positioning projections 19a and 19b of the loading arm 19 cooperate, reliably aligning the center of the 8-cm optical disc with the center of the turntable 15.

Although not described in detail, as the optical disc is inserted into the optical disc apparatus 1, the turntable 15 (disc motor 13) is moved upwards from the bottom cover (housing) 11. The optical disc is thereby clamped on the turntable 15. As a result, the optical disc is set in the optical disc apparatus 1 and can be rotated, as shown in FIG. 7.

As shown in FIG. 9A, the 8-cm optical disc is guided into the optical disc apparatus 1, while contacting the first and second positioning projections 19a and 19b of the loading arm 19 and being positioned near the first and second disc guides 23 and 25 and near the fulcrums 23a and 25a thereof. As a cam slider 31 is driven by a loading motor (not shown), the optical disc is further inserted into the optical disc drive 1 by the disc holding pin 27a of the disc holding lever 27.

As the cam slider 31 further slides, the engagement projection CO of the connection lever 21 enters an LO cam POS (8LO). Then, the first and second positioning projections 19a and 19b of the loading arm 19 are moved, guiding the optical disc until the center of the disc aligns with the center of the turntable 15 (or the shaft of the disc motor 13). At the same time, the engagement projection HO of the disc holding lever 27 enters the HO cam POS (8LO). Then, the disc holding pin 27a moves, pushing the optical disc until the center of the disc aligns with the center of the turntable 15 (or the shaft of the disc motor 13). The optical disc is thereby set at a prescribed position on the turntable 15, where it should be clamped. Since the disc has a diameter of 8 cm, the cam slider 31 does not move so much as in the case of inserting a 12-cm disc.

Thus, the centering of both an 8- and a 12-cm optical disc can be accomplished as the rotation of the loading arm 19 is controlled in series by using a cam groove. Hence, the optical disc of either diameter can be positioned by two projections 19a and 29b provided on only one loading arm 19 and only one pin 27a provided on the disc holding lever 27.

In order to rotate the 8-cm optical disc, the spring-force releasing mechanism (not shown) releases the disc holding lever 27 and the loading arm 19 from the tension that biases them toward the turntable 15 shown in FIG. 10. Thus, the disc holding lever 27 and the loading arm 19 are inhibited from contacting the outer circumference of the optical disc. Nonetheless, the disc holding lever 27 and the loading arm 19 are moved outwards, each to the same position as in the case of rotating the 12-cm optical disc. That is, the lever 17 and the arm 19 only need to be spaced from the outer circumference of the 8-cm optical disc to allow the disc to rotate. Therefore, no specific positions are preset, to which the lever 17 and the arm 19 should be moved outwards.

No matter whether the disc being inserted has a diameter of 12 or 8 cm, the cam slider 31 operates when the optical disc reaches the deepest position it has in the optical disc apparatus 1. When the optical disc reaches the deepest position, the engagement projection CO of the loading arm 19 enters the LO cam POS (END), and the engagement projection HO of the disc holding lever 27 enters the HO cam POS (END). As a result, the projections 19a and 19b and the pin 27a move away from the outer circumference of the optical disc. The disc can therefore rotate.

In order to eject the 8-cm optical disc, the loading arm 19 is rotated in the opposite direction (to move the optical disc to the disc-ejecting position). The 8-cm optical disc can therefore be ejected with ease.

The optical disc apparatus (optical disc drive) according to the first embodiment of the present invention is a so-called slot-in type, as mentioned above. In the apparatus, only one rotatable member (i.e., loading arm) and two positioning members provided, respectively, on the distal end and any other part of the rotatable component can support and guide an optical disc, regardless of the diameter of the optical disc, until the center of the disc aligns with the center of the turntable.

Further, the optical disc can be easily ejected from the optical disc apparatus, merely by rotating the rotatable member is rotated in the opposite direction, away from the outer circumference of the optical disc.

More specifically, the loading arm 19 can rotate around the fulcrum 17 in a dead space available even while an optical disc is set at the deepest position in the disc drive 1 (at the back of the turntable). Two projections 19a and 19b are provided on the loading arm 19 and serve to position the optical disc, no matter whether the disc has a diameter of 12 or 8 cm. The disc holding lever 27 configured to rotate toward the loading arm 19 has a pin 28a at one end. The pin 28a cooperates with projections 19a and 19b to guide the optical disc (12- or 8-cm disc) to the centering position (on the turntable), in accordance with the angle by which the loading arm 19 rotates.

As schematically shown in FIG. 8A, 8B, 9A and 9B, the loading arm 19 and the disc holding lever 27, which are pulled toward each other by the spring member 29, are connected to the connection lever 21. As the engagement projection CO of the connection lever 21 is guided in the cam groove (LO) made in the slider 31, the loading arm 19 can be set at “disc-waiting position,” “disc-transporting position,” “8-cm-disc setting position,” “12-cm-disc setting position” and “loading-end position.”

As has been described, in the slot-in type, optical disc apparatus according to the embodiment of this invention, the two projections integrally formed with one rotation arm can guide an optical disc to the centering position, regardless of the diameter of the optical disc. The disc-loading mechanism thus has a simple structure and, therefore, comprises a few components. Hence, the disc-loading mechanism can be light and can reliably operate.

Further, the optical disc apparatus has a disc holding mechanism that can push the optical disc to the two projections integrally formed with the rotation arm, from across the turntable. The disc holding mechanism can therefore reliably load and eject the optical disc into and from the optical disc apparatus.

Moreover, since the disc holding mechanism pushes the optical disc to the two projections integrally formed with the rotation arm, from across the turntable, the center of the optical disc can be reliably aligned with the center of the turntable, regardless of the size of the disc, only if the rotation arm is rotated in accordance with the size of the optical disc. This enhances the precision of clamping the optical disc.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An optical disc apparatus comprising:
a turntable which supports an optical disc, rotating a recording surface of the optical disc at a predetermined speed;
an arm member which rotates around a fulcrum located at the rear of the turn table, with respect to a direction of inserting the optical disc and guiding the same to the turntable, and which has at least two projections spaced apart for a distance corresponding to the diameter of the optical disc;
a guide unit which rotates around a fulcrum set at a prescribed position, not interfering the optical disc being guided to the turntable and remaining opposed to the arm member across the turntable, which has an guiding member able to contact, at least at one point, an outer circumference of the optical disc to be guided to the turntable, and which guides the optical disc toward the arm member;
guide members which guides an optical disc having a first diameter to the arm member, while remaining at a first position, and to guide an optical disc having a second diameter larger than the first diameter, while remaining at a second position where the guide members are spaced by a longer distance than while remaining at the first position; and
a cam slider which controls first the rotation of the arm member and the rotation of the guide unit in series.

2. The apparatus according to claim 1, wherein the arm member and the guide unit are biased toward each other cross the turntable.

3. The apparatus according to claim 1, wherein the two projections of the arm member and the guide unit hold the optical disc.

4. The apparatus according to claim 1, wherein the arm member and the guide unit cooperate to align a center of the optical disc having the first diameter or optical disc having the second diameter, with a center of the turntable, as the cam slider is moved.

5. The apparatus according to claim 1, further comprising:
a plurality of disc-guiding members which guide the optical disc having the first diameter to the arm member, while remaining at a first position, and which guide the optical disc having the second diameter to the arm member, while remaining at a second position where the disc-guiding members are spaced by a longer distance than while remaining at the first position.

6. The apparatus according to claim 5, wherein the plurality of disc-guiding members are able to deform in a way at the first position and in a different way at the second position, in accordance with the diameter of the optical disc to guide.

7. The apparatus according to claim 5, wherein the fulcrum around which the arm member rotates with respect to the turntable is located at a longer distance from the turntable than from the outer circumference of a largest optical disc inserted.

8. The apparatus according to claim 5, wherein the guide unit orientates the optical disc being inserted, to the plurality of disc-guiding members, the guide members and the arm member.

9. An optical disc apparatus comprising:
a first rotation mechanism which exerts force acting in a prescribed direction, at a point on an outer circumference of an optical disc;
a second rotation mechanism which holds the optical disc biased by the first rotating mechanism, at a point on the outer circumference of the optical disc, and which rotates as the first rotation mechanism rotates, in the same direction as the first rotation mechanism;
a cam slider which rotates the first and second rotation mechanisms together, through a serial motion; and
a spring member which exerts a force that biases the first and second rotation mechanism toward each other,
wherein the second rotation mechanism further holds the optical disc while rotating the optical disc in the same direction as the first rotation mechanism rotates, at a point other than the point that is defined by an angle through which the first rotation mechanism rotates and by a diameter of the optical disc.

10. The apparatus according to claim 9, further comprising:
a plurality of guide members which guide an optical disc having the first diameter to the arm member, while remaining at a first position, and which guide an optical disc having a second diameter to the second rotation mechanism, while remaining at a second position where the guide members are spaced by a longer distance than while remaining at the first position.

11. A slot-in type, optical disc apparatus comprising:
a loading arm which has two projections, respectively, at a distal end and at a position prescribed in accordance with a difference in diameter between optical discs, which is configured to rotate in a direction in which an optical disc is inserted, which rotates when the optical disc contacts at least the projection provided at the distal end, and which positions the optical disc when rotated through an angle prescribed in accordance with the difference in diameter between the optical discs, by using the two projections spaced apart by a distance prescribed in accordance with the difference in diameter between the optical discs; and
a turntable which holds an optical disc transported as the loading arm rotates and which rotates the optical disc,
wherein the optical disc is ejected when the loading arm is rotated in the opposite direction.
